(19) United States
(12) Patent Application Publication
(10) Pub. No.: US 2016/0233462 A1
(43) Pub. Date: Aug. 11, 2016

(54) METHOD FOR FIXING ELECTRODES OF FLEXIBLE BATTERY

(71) Applicant: Exa Energy Technology Co., Ltd., Taichung City (TW)

(72) Inventors: LUN-CHIEH HO, Taichung City (TW); YIH-SONG JAN, Taipei City (TW)

(21) Appl. No.: 15/017,276

(22) Filed: Feb. 5, 2016

(30) Foreign Application Priority Data
Feb. 6, 2015 (TW) 104104098

(51) Int. Cl. H01M 2/02

(52) U.S. Cl. CPC H01M 2/0275

(57) ABSTRACT

A method for fixing electrodes of flexible battery of the present invention includes the following steps. Prepare a cathode plate and an anode plate each of which has a first face having activating agent and a second face which is coarse. Each of the cathode plate and the anode plate has a conducting portion and a connecting portion. Place the cathode plate and the anode plate adjacently and make the second faces facing upward. Cover the connecting portions with an aluminum foil whose lower face covered with a plastic material. Pressing downward and heating the upper face of the aluminum foil so that the plastic material is adhered onto the second faces of the cathode plate and anode plate. Thus, adhesive is prevented, and thickness of battery is reduced.

### BACKGROUND OF THE INVENTION

1. Field of the Invention

The present invention relates to a method for fixing electrodes of flexible battery.

2. Description of the Prior Art

A conventional flexible battery includes a shell made of aluminum foil, an anode plate, a cathode plate, and electrolysis fluid. To prevent the anode and cathode plates from floating in the shell, the plates are usually fixed on the inner wall of the shell by means of adhesive spread on the plates.

However, spreading the adhesive results in higher cost and much complicated process. On the other hand, the adhesive contacts the electrolysis fluid so as to be easy to decompose. In addition, the thickness of the battery cannot be reduced due to the adhesive.

### SUMMARY OF THE INVENTION

The main object of the present invention is to provide a method for fixing electrodes of flexible battery to prevent from using adhesive and to make the flexible battery thinner.

To achieve the above and other objects, a method for fixing electrodes of flexible battery includes the following steps.

(1) Prepare an anode plate and a cathode plate: Each of the anode plate and the cathode plate is a metal sheet and has a conducting portion and a connecting portion at two ends thereof The connecting portion has a first face and a second face. The first face is spread with an activating agent. The second face has a coarse surface.

(2) Cover with an aluminum foil: Align the anode plate and the cathode plate adjacently and make the second faces thereof face upward. Cover the connecting portions of the anode plate and the cathode plate with the aluminum foil. At least part of the conducting portion of each of the anode plate and the cathode plate is exposed outside the aluminum foil. A face of the aluminum foil facing downward contacts the second faces of the anode plate and the cathode plate. The face of the aluminum foil facing downward is spread with a plastic layer.

(3) Thermo compression: Press and heat the aluminum foil with a thermo compression device located above the aluminum foil so that the plastic layer is adhered to the second face of each of the anode plate and the cathode plate.

Thereby, no adhesive is needed, and the battery can be thinner.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an illustration of an anode plate and a cathode plate of the present invention;

FIG. 2 is an illustration of an anode plate and a cathode plate of the present invention at another angle;

FIGS. 3 to 6 are illustrations of steps of the present invention.

### DETAILED DESCRIPTION OF THE PREFERRED EMBODIMENTS

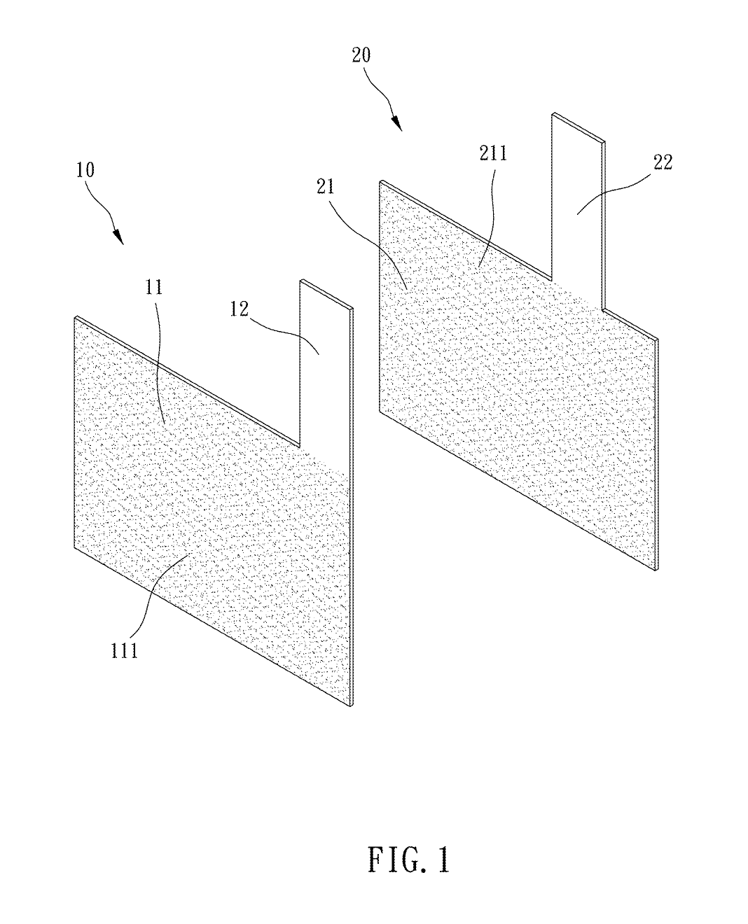

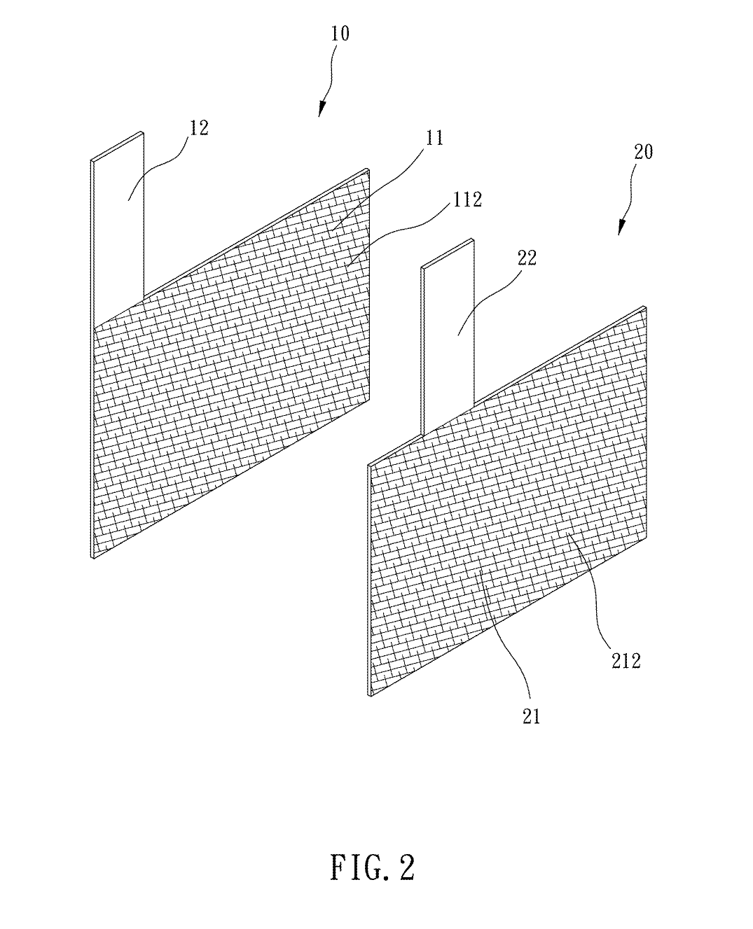

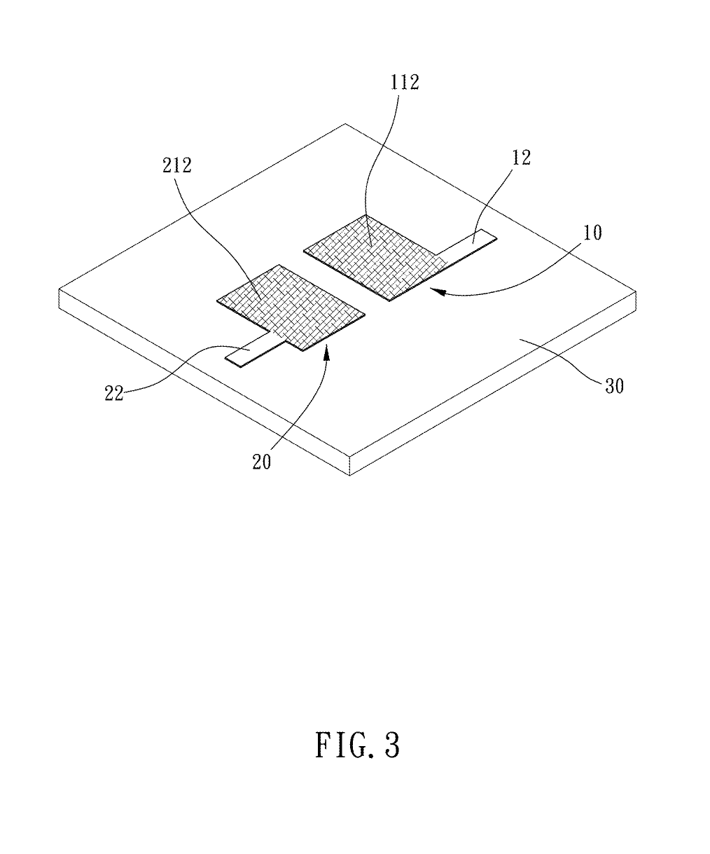

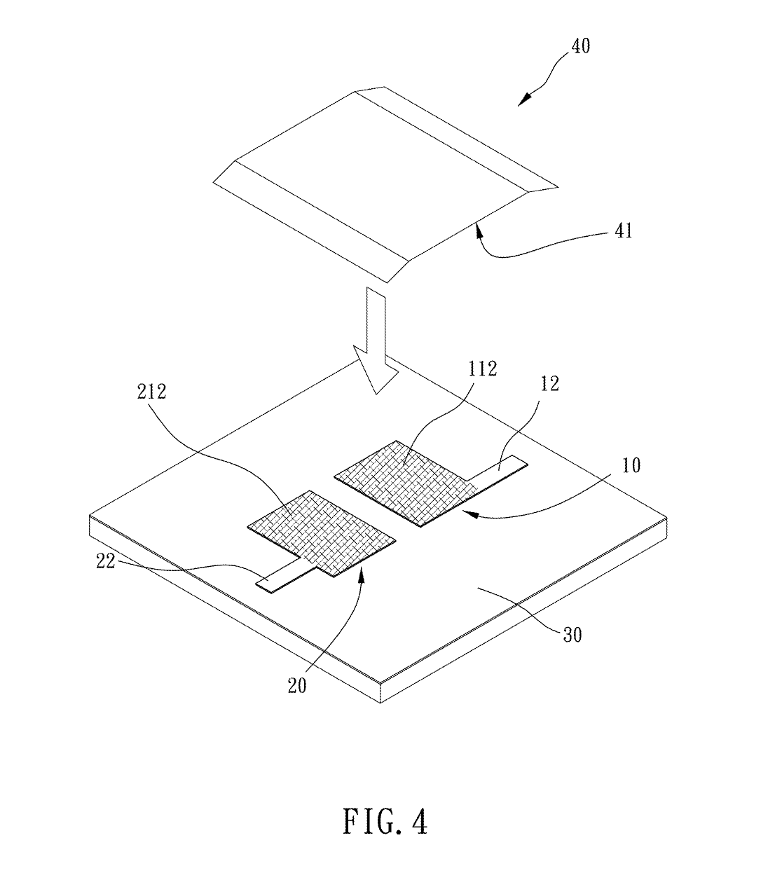

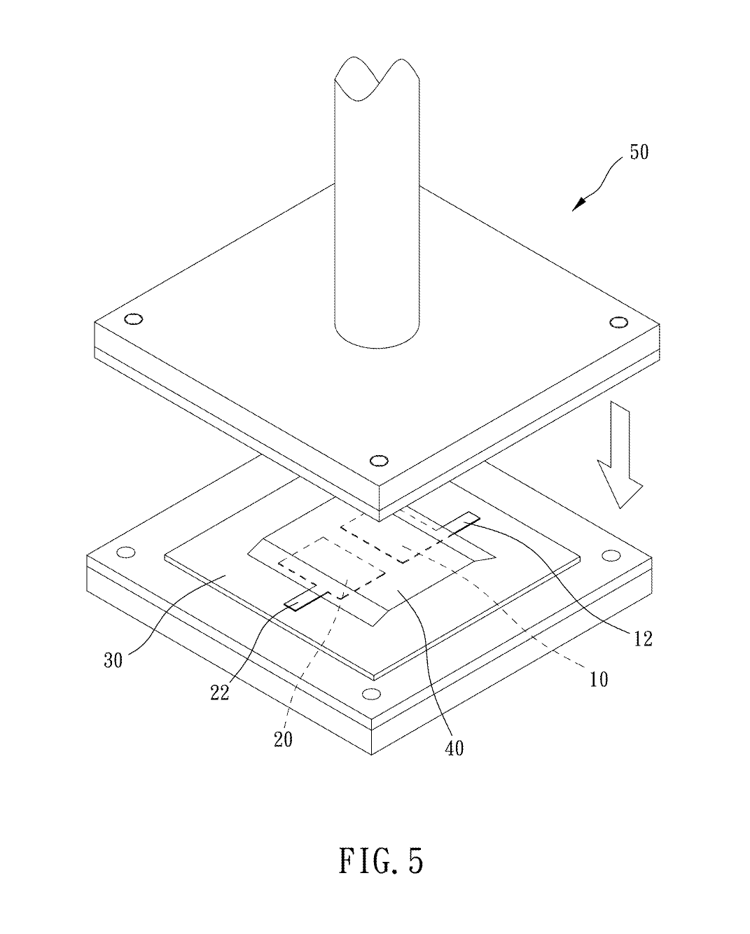

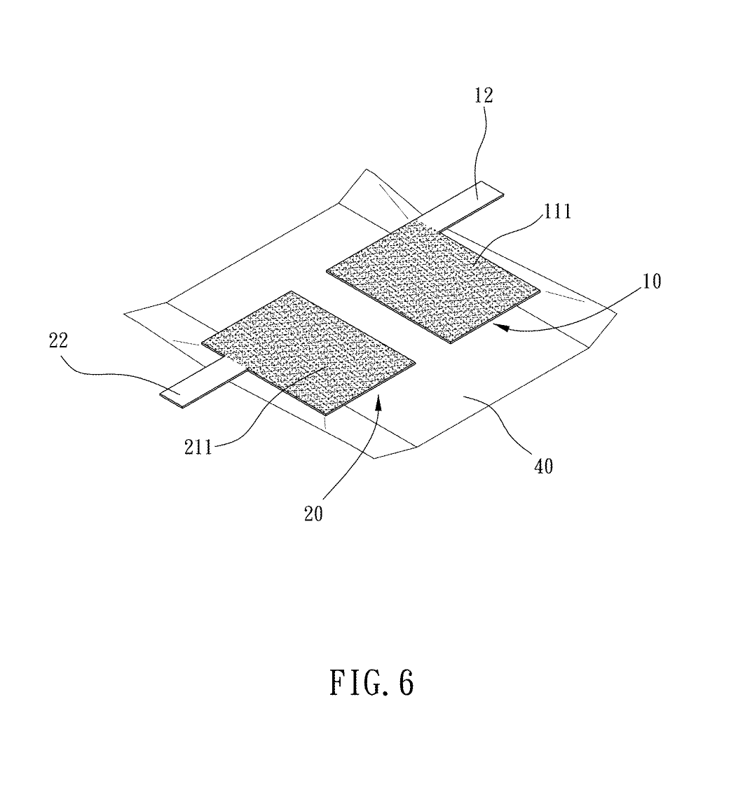

Please refer to FIG. 1 to FIG. 6, the method for fixing electrodes of flexible battery of the present invention includes the following steps.

(1) Prepare an anode plate 10 and a cathode plate 20: Each of the anode plate 10 and the cathode plate 20 is a metal sheet. In the present embodiment, the anode plate is made of aluminum, and the cathode plate is made of copper. Each of the anode plate 10 and the cathode plate 20 has a conducting portion 11,22 and a connecting portion 11,21 at two opposite ends. The connecting portion 11,21 has a first face 111,211 and a second face 112,212. The first face 111,211 is spread with an activating agent, and the second face 112,212 has a coarse surface. The conducting portion 12,22 is elongated. About the coarse surface, at least one of the anode plate and the cathode plate is made of electric erosion metal foil to directly form the coarse surface. Alternatively, at least one of the anode plate and the cathode plate is abraded to from the coarse surface or spread with a coating having bumps to form the coarse surface.

(2) Cover with the aluminum foil 40: Align the anode plate 10 and the cathode plate 20 adjacently and place them on a silicon sheet 30 to make the second faces 112,212 face upward. Cover the connecting portions 11,21 with an aluminum foil 40. At least part of each of the conducting portions 12,22 is exposed outside the aluminum foil 40. The face of the aluminum foil 40 facing downward contacts the second faces 112,212 of the anode plate 10 and the cathode plate 20 and is spread with a plastic layer 41. In the present embodiment, the plastic layer 41 is made of polypropylene.

(3) Thermo compression: Pressing and heating the aluminum foil 40 with a thermo compression device 50 located above the aluminum foil 40 to make the plastic layer 41 adhere onto the second faces 112,212 of the anode plate 10 and the cathode plate 20. In the present embodiment, the thermo compression step is processed under a pressure of 1-6 kilograms per centimeter square and a temperature of 100-200 degrees Celsius.

Thereafter, place a separation membrane or other similar object between the anode plate and the cathode plate to separate them, and then fold the aluminum foil to package followed by filling with electrolysis fluid. Thereby, the flexible battery is provided.

In conclusion, the anode plate and the cathode plate can be fixed onto the aluminum foil easily, and performance of adhesion is improved because the coarse surface is thermo compressed to the plastic layer. Besides, no adhesive is needed so that cost is reduced and that the battery may be thinner.

What is claimed is:

1. A method for fixing electrodes of flexible battery, including steps of:
(1) preparing an anode plate and a cathode plate: each of the anode plate and the cathode plate being a metal sheet and having a conducting portion and a connecting portion at two ends thereof, the connecting portion having a first face and a second face, the first face being spread with an activating agent, the second face having a coarse surface;
(2) covering with a aluminum foil: aligning the anode plate and the cathode plate adjacently and making the second faces thereof face upward, covering the connecting portions of the anode plate and the cathode plate with the aluminum foil, at least part of the conducting portion of each of the anode plate and the cathode plate being exposed outside the aluminum foil, a face of the aluminum foil facing downward contacting the second faces of the anode plate and the cathode plate, the face of the aluminum foil facing downward being spread with a plastic layer;
(3) thermo compression: pressing and heating the aluminum foil with a thermo compression device located above the aluminum foil so that the plastic layer is adhered to the second face of each of the anode plate and the cathode plate.

2. The method for fixing electrodes of flexible battery of claim 1, wherein the conducting portion of each of the anode plate and the cathode plate is elongated.

3. The method for fixing electrodes of flexible battery of claim 1, wherein at least one of the anode plate and the cathode plate is made by am electric erosion metal foil to directly form the coarse surface.

4. The method for fixing electrodes of flexible battery of claim 1, wherein the second face of at least one of the anode plate and the cathode plate is abraded to form the coarse surface.

5. The method for fixing electrodes of flexible battery of claim 1, wherein the second face of at least one of the anode plate and the cathode plate is spread with a coating with bumps.

6. The method for fixing electrodes of flexible battery of claim 1, wherein the anode plate is made of aluminum, the cathode plate is made of copper.

7. The method for fixing electrodes of flexible battery of claim 1, wherein the anode plate and the cathode plate are placed on a silicone sheet to be processed during the step (2).

8. The method for fixing electrodes of flexible battery of claim 1, wherein the aluminum foil is thermo compressed under a pressure of 1-6 kilograms per centimeter square and a temperature of 100-200 degrees Celsius.

9. The method for fixing electrodes of flexible battery of claim 1, wherein the plastic layer is made of polypropylene.
